(19) United States
(12) Patent Application Publication
(10) Pub. No.: US 2009/0090423 A1
(43) Pub. Date: Apr. 9, 2009

(54) Method of forming a current that generates Tornado Like Jets (TLJ) embedded into the flow, and the surface for its implementation

(76) Inventors: Gennady Iraklievich Kiknadze, Moscow (RU); Ivan Alexandrovich Gachechiladze, Moscow (RU)

Correspondence Address: DeMont & Breyer, LLC, 100 Commons Way, Ste. 250, Holmdel, NJ, 07733, US

(21) Appl. No.: 11/817,788

(22) PCT Filed: Mar. 4, 2005
(86) PCT No.: PCT/RU05/00096

§ 371 Date: Dec. 18, 2008

(51) Int. Cl. F15D 1/02; F15D 1/06

(52) U.S. Cl. 138/39; 138/44; 244/200

(57) ABSTRACT

The invention relates to hydroaeromechanics, heat and mass exchange and power engineering, medical instrument engineering, and other branches of economy, in which the motion of a continuous medium (gases, liquids, and mixtures thereof) defines the functional and technical-and-economical efficiency. It relates to the method of forming the currents of a new type whose flow has the embedded tornado-like jets connected with the boundary layer on the streamlined surfaces, sucking this layer out and transferring the sucked mass into the main stream. In accordance with the suggested current forming method, the streamlined surfaces are made in the form of alternating originally smooth and curvilinear portions, the latter having the curvature of different signs and interfacing at the point where they have a common tangent; the ratio of the curvature radii of these portions: R₍₊₎—convex and R₍₋₎—concave, ensures the formation of the suggested current within a wide range of variation of this ratio; such relieves have a concave surface of spherical form with the curvature radius R₍₋₎ or a surface of elliptical form with the curvature radii Rₘᵢₙ₍₋₎ and Rₘₐₓ₍₋₎ joined with the originally smooth surface by means of the convex curvilinear toroidal-shaped slopes with the curvature radius R₍₊₎ and/or the surfaces of hyperbolic or elliptical form having at the points of conjunction with the originally smooth surface and concave surface of the relief the curvature radii Rₘᵢₙ₍₋₎ and Rₘₐₓ₍₋₎ whose ratio to the curvature radii of the concave portion of the dimple is within the range 10⁻⁶≦R₍₊₎/R₍₋₎≦1, while the concave portion is made smooth or with a fairing, and the ratio of the height H of each dimple to the dimple diameter D is within the following range 0.02≦H/D≦0.5.

### FIELD OF INVENTION

The invention relates to hydroaeromechanics and thermophysics and describes the method and device for generating tornado like jets embedded into the flow to control the boundary layers formed by a relative movement of the surfaces of different bodies, or channels, and a continuous medium (gases, liquids, and two-phase or multicomponent mixtures thereof).

### BACKGROUND OF THE INVENTION

The closest prior art of this invention is patent RU 2020304 dated 30.09.1994, proposing streamlined surfaces, or heat-mass exchange surfaces, being the boundary surfaces between the relatively moving continuous medium (gases, liquids, two-phase or multi-component mixtures) and solid wall, originally flat, of cylindrical, conic or any other shape, that makes it possible to intensify the transfer of heat, mass, etc. between the boundary, or near-wall, flow layers and the main current owing to formation of the dynamic vortex structures by means of applying a three-dimensional concave or convex relief onto the surface. The ranges of sizes defining this relief are connected with the aerohydrodynamic characteristics describing the processes in the boundary and near-wall layers of the current.

The streamlined surface, according to the proposed design, comprises three-dimensional concave or convex relief elements, distributed on its surface and having rounded transition portions joining these portions with the originally smooth surface; any cross-section of the relief elements that is parallel to the plane in which the three nearest apexes lie having a form of a smooth closed line.

Disadvantage of this prior art patent is that it is mainly aimed at solving the heat-exchange problems and suggests no optimal solutions to increase critical boiling heat loads, reduce cavitational destruction of surfaces, reduce the rate of foreign matter deposition from the flows of energy carriers to the streamlined surfaces, reduce aerohydrodynamic drag of streamlined surfaces and resistance between the friction surfaces of friction couples, etc., as well as no relationships between the radius of curvature of the surfaces having a curvature of different sign in the dimple.

### DISCLOSURE OF THE INVENTION

The subject of the present invention is to create a method and a device for generation of the currents of gases, liquids, and two-phase or multi-component mixtures thereof forming tornado like jets embedded into their flows.

The technical results of implementation of the invention will be as follows:
reduction of the aerohydrodynamic drag of the energy-exchange channel surfaces having said curvilinear portions streamlined by the flows of continuous medium, and of the bodies having streamlined surfaces of the same shapes, moving in the air, in water areas or by land at the speed sufficient for self-organization of the secondary tornado lake jets;
   intensification of heat-mass exchange between the flows of the heat-carrying agents and power interchange surfaces comprising the suggested curvilinear portions on which the tornado-like jets are formed significantly accelerating the exchange processes between the flow of the medium and the surface with the hydraulic drag lagging behind the rate of intensification;
increase of the critical heat loads in liquid heat carriers by shaping said surface in the above mentioned way and creating on them the conditions for self-organization of the secondary tornado-like jets changing the kinetics of the mass transfer in the process of phase transformation in the liquid energy carriers;
   prevention of cavitations destruction of the surfaces in the flows of liquids by shaping said surface in the above mentioned way and creating on them the conditions for self-organization of the secondary tornado-like jets preventing development of the steam and gas formations (bubbles) on said surfaces and evacuating the centers of such formations out of the streamlined surface;
   reduction of adsorption of dirt, foreign matters and building-up of deposits from the moving medium on the energy exchange surfaces of said forms by carrying-out the foreign matters into the main flow in the form of e.g. ash or a matter undergoing phase transformations, including the products of incomplete burning of fuels, salt deposits, other adsorbing matters including ice and snow;
   reduction of friction between the solid friction surfaces e.g. in the friction couples by shaping these surfaces so that they contain the curvilinear portions forming the tornado-like jets acting as unique vortex bearings.

Such wide range of effects upon the primary and advantageous for engineering practice characteristics of aerodynamic, mass exchange, tribo-, and thermal processes is the result of experimental and theoretical research that has resulted in discovery of a new class of flows of viscous continuous media and development of the below described method and device for generating said class of currents representing the flows with embedded tornado-like jets.

According to the suggested method, the streamlines surface is shaped in a form comprising alternating curvilinear portions and the portions of originally smooth surface located in-between, while one part of the curvilinear surface of the dimples which is outer in relation to their geometrical center has a convex form and is characterized by the curvature radius R₍₊₎ and the other, or inner, portion of the curvilinear surface located around their geometrical center has a concave form and is characterized by the curvature radius R₍₋₎, the relationship between these radii being within the following range:

10⁻⁶≦R₍₊₎/R₍₋₎≦1;

onto the surface having said form a flow of continuous working medium is directed streaming past the surface, a body with so formed boundary surface is driven in gases, liquids or mixtures thereof, that promotes on such surfaces self-organization of the secondary tornado-like jets embedded into the generated flow to use one or an aggregate of the following properties accompanying the discovered phenomenon:
reduction of the aerohydrodynamic drag of the energy-exchange channel surfaces having said curvilinear portions streamlined by the flows of continuous medium, and of the bodies having streamlined surfaces of the same shapes, moving in the air, in water areas or by land at the speed sufficient for self-organization of the secondary tornado lake jets;
intensification of heat-mass exchange between the flows of the heat-carrying agents and power interchange surfaces comprising the suggested curvilinear portions on which the tornado-like jets are formed significantly accelerating the exchange processes between the flow of the medium and the surface with the hydraulic drag lagging behind the rate of intensification;
increase of the critical heat loads in liquid heat carriers by shaping said surface in the above mentioned way and creating on them the conditions for self-organization of the secondary tornado-like jets changing the kinetics of the mass transfer in the process of phase transformation in the liquid energy carriers;
prevention of cavitations destruction of the surfaces in the flows of liquids by shaping said surface in the above mentioned way and creating on them the conditions for self-organization of the secondary tornado-like jets preventing development of the steam and gas formations (bubbles) on said surfaces and evacuating the centers of such formations out of the streamlined surface;
reduction of adsorption of dirt, foreign matters and building-up of deposits from the moving medium on the energy exchange surfaces of said forms by carrying-out the foreign matters into the main flow in the form of e.g. ash or a matter undergoing phase transformations, including the products of incomplete burning of fuels, salt deposits, other adsorbing matters including ice and snow;
reduction of friction between the solid friction surfaces e.g. in the friction couples by shaping these surfaces so that they contain the curvilinear portions forming the tornado-like jets acting as unique vortex bearings.

It has been experimentally proven that self-organization of tornado-like jets occurs during relative movement of a viscous continuous medium and a boundary surface due to the form of the relief that generates at the moving medium to the surface interface the forces directed from the surface to the flow, including:
braking forces initiating in the concave portion of the dimple a reverse current developing from the front upstream slopes of the dimple against the main stream and joining on the slopes meeting the flow with the main flow velocity U∞; such joining generated inside the dimple a circulation of the medium with the azimuth velocity U. , here U_{φ}=kU_{∞}., where k<1, as in the flow boundary layer the flow velocity is lower than in its core;
mass inertial force directed on the convex slopes of the dimple along the curvature radius towards their surface generate in the medium moving along these slopes a two-dimensional velocity field comprising the radial and azimuthal in relation to the dimple velocity components; this movement of the medium along the curvilinear slopes results in self-organization of the tree-dimensional vortex boundary layer comprising Görtler vortexes and ensembles thereof adding to the flow on the dimple slopes high dynamics; further forming of the tornado-like flow occurs on the concave slopes of the dimples also under the mass inertial forces directed from the surface to the center of curvature along its radii. In these zones of the relief, the inertial forces add to the twisted jets generated in the dimples the longitudinal velocity component, additional radial convergence, increasing the twisting effect i.e. the azimuthal velocity of the medium with the reduction of the jet radius and provide the pressure profile that is necessary to transfer the mass of the medium sucked into the tornado-like jet from the dimple to the main stream;
the forces such as the Magnus forces ensuring the rise of the secondary circulation possessing vortex structure from the dimple into the oncoming flow and pulling one of the ends of this vortex into the main stream thereby finalizing generation of the flow with embedded secondary tornado-like jets.

The values of the above forces and directions of their action onto the structure of the generated flow are controlled by the preset forms of the dimples, density of their distribution in relation to the area of the originally smooth surface, and by the regimes of the medium flow motion in relation to the surface containing the dimples; for example, in the flow around the dimple whose relief is described by the curvature radii R₍₊₎ and R₍₋₎, the flow moving in relation to its convex slopes is subjected to the mass inertial forces pressing the flow to the surface and making the flow more or less, depending of the selected curvature radii, radial convergence to the center of the dimple, generating between the curvilinear surface and the flow a boundary layer comprising the surface vortexes of the Görtler type or ensembles thereof, and such boundary layer accompanies the generated flow on the concave part of the dimple too. The three-dimensional boundary layer makes the twisted jet generated in the dimple more dynamic relative to the curvilinear surface and stabilizes its draining to the main stream building of these vortexes a fairing formed by the structure of the twisted flow and selected form of the curvilinear surface of the dimple.

The claimed technical result is achieved by means of combining the described experimental factors with the theoretical substantiations to form the method of generating a flow with embedded tornado-like jets linking the flow boundary layer with its core and providing the drainage of a part of the boundary layer to the main stream, characterizing in that onto the streamlined surface a relief is applied representing the areas of originally smooth surface alternating with the areas of the surface of a curvilinear shape in the form of the dimples, and a portion of the curvilinear surface of the dimple that is joining the originally smooth surface has a convex shape with the curvature radius R₍₊₎, while the other part of the dimple surface has a concave shape with the curvature radius R₍₋₎, and the convex and concave parts are interfacing in the point in which they have the common tangent, and the ratio of the curvature radii is within the range of 10⁻⁶≦R₍₊₎/R₍₋)≦1, ensure interaction between the flow and the surface, create on account of the selected relief a field of forces comprising the drag forces, mass inertial forces and Magnus type forces influencing the flow and generating a tornado-like jets coming out of the dimple, suck out by means of said jet the boundary layer from the dimple and from a part of the surface around it, transfer the sucked out mass to the main stream and stabilize the twisted current.

The claimed technical result is also achieved by that the surface located in the flow of continuous medium is characterized by a curvilinear relief in a form of separate double curvature dimples each comprising a concave portion of the dimple surface including a sphere segment like surface with the curvature radius R₍₋₎, or an elliptical, hyperbolic and/or any other second-order surface whose form is characterized by the curvature radii Rₘᵢₙ₍₋₎ and Rₘₐₓ₍₋₎, joined with the originally smooth surface by curvilinear toroidal-shaped slopes with the curvature radius R₍₊₎, and/or the surfaces of hyperbolic, parabolic or elliptical form having at the interface of the originally smooth surface with the concave surface of the relief the curvature radii Rₘᵢₙ₍₊₎ and Rₘₐₓ₍₊₎, whose ratio to the curvature radii of the concave portion of the dimple is defined by the following ranges:

10⁻⁶≦Rₘᵢₙ₍₊₎/R⁽⁻⁾≦1 and 10⁻⁶≦R_{max(+)/R}₍₋₎≦1,

therewith, the concave portion is made smooth or provided with a fairing, and the ratio of the dimple depth H to the dimple diameter D is within the following range:

0.02≦H/D≦0.5

with their density of distribution f on the streamlined surface being within the following range:

0.1≦f≦0.8

The technical result is also achieved on account of the device on the streamlined curvilinear surfaces of the “fairings” in the form of the bodies of revolution whose projections on the plane containing in each of the dimples the normal line towards the center of the concave surfaces and the central meridian are defined by the following relationship:

rᵢ²hᵢ=const,

where rᵢ is the radius of the fairing, and hi is its height assuming the values within the following ranges:

10⁻⁵≦rᵢ/R₍₋₎≦1 and 10⁻⁵≦rᵢ/R₍₋₎≦1,

therewith, the dimple radius rₛₚ of the concave spherical portion of the curvilinear surface having the curvature radius R₍₋₎ is defined by the following relationship:

rₛₚ=(2hₛₚR₍₋₎−hₛₚ ²)_{0,5},

where hₛₚ is the depth of the concave portions of the relief,

and the curvature radius of the convex portion of the dimple is linked with its dimensions by the following relationship:

$${R}_{( + )} = \frac{{( {r}_{c} - {r}_{sp} )}^{2} + {( {h}_{c} - {h}_{sp} )}^{2}}{2 ( {h}_{c} - {h}_{sp} )} ,$$

where r_{c} is the dimple radius, h_{c} is the dimple depth.

The fairing can be also made in a form of at least one secondary depression located on the concave portions of the relief, generating inside the primary dimples the tertiary tornado-like jet acting as the fairing.

In addition, the fairing can be made in a form of at least one set of depressions of various diameters located on the concave portion of the primary dimple of the relief using the one inside the other method.

### BRIEF DESCRIPTION OF THE DRAWINGS OF THE INVENTION

FIG. 1 shows a detail of the streamlined surface representing the embodiment of the suggested method and comprising a single dimple.

FIG. 2 shows the streamlined surface with a fairing represented by a double dimple.

FIG. 3 shows the streamlined surface with a fairing in the form of depressions.

FIG. 4 shows the streamlined surface with a fairing in the form of a set of small depressions on its surface.

FIG. 5 shows the diagram of the flow lines of the medium engaged into the generation of the secondary twisted structure in the dimple at low velocities.

FIG. 6 illustrates the above process visualized by photography.

FIG. 7 represents visualization of the process of vortex compression in the dimple and suction of the medium from the near-wall flow layer into the vortex.

FIG. 8 represents visualization of the flow past a relief of 3D depressions.

FIG. 9 shows the result of measuring the thickness of the boundary layer on the surface with a dimple. 1—smooth surface, 2—surface with a dimple; the maximum on the curve corresponds to the coordinates of the zone of tornado-like jet outflow from the dimple.

FIG. 10 represents the experimentally measured pressure profile on the dimple surface. Reduced pressure on the periphery corresponds to suction of the medium from the boundary layer of the main stream into the dimple, while the zone of increased pressure (dome) defines the pressure at the end of the self-organized tornado-like jet, defining the outflow of the mass of the medium sucked in by the secondary tornado-like jet into the main stream; this maximum pressure zone in the dimple coincides with the boundary layer maximum thickness zone above the dimple in FIG. 9 and with the location of the fairing in FIG. 11.

FIG. 11 represents visualization of the flow past the dimple, demonstrating generation of the Görtler vortexes in the form of a “braid” indicated by the arrows, and the fairing built up by the structure of the secondary twisted flow formed by the oncoming flow in the depression of selected form.

### EMBODIMENTS OF THE INVENTION

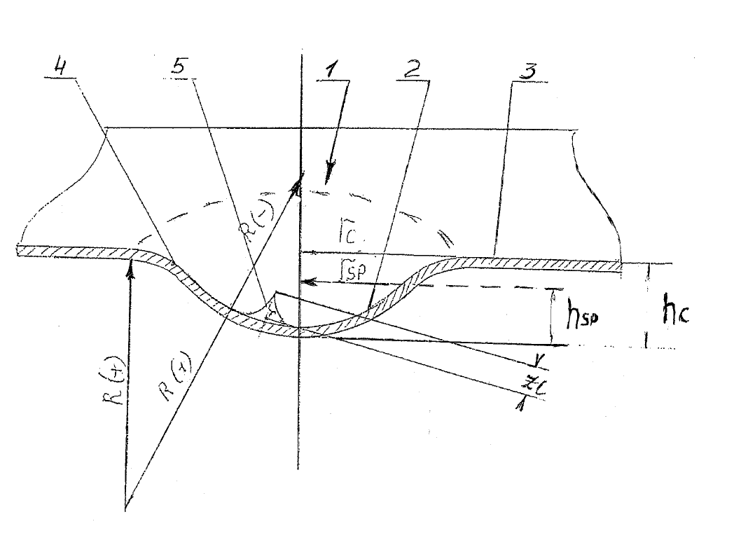

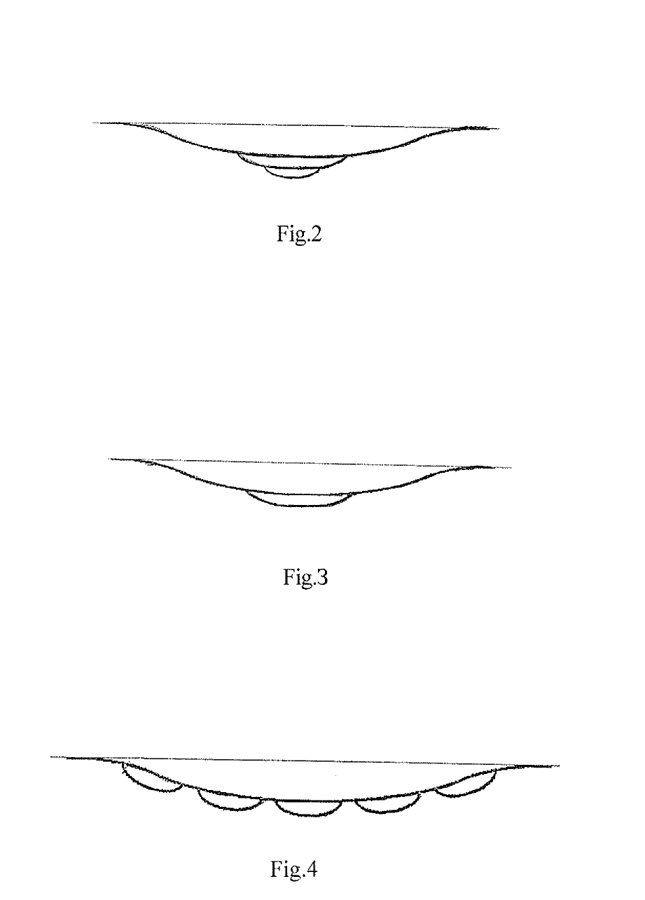

On the streamlined surface (FIG. 1) a curvilinear relief is applied having a form of individual double curvature dimples 1 each comprising a concave portion 2 of the inner surface, including a spherical surface with the curvature radius R₍₋₎₋, or an elliptical surface with the curvature radii Rₘᵢₙ₍₋₎ and Rₘₐₓ₍₋₎ joined with the originally smooth surface 3 by curvilinear slopes 4 of a toroidal surface with the curvature radius R₍₊₎ and/or hyperbolic or elliptical surfaces having at the interfaces with the originally smooth surface and the concave surface the curvature radii Rₘᵢₙ₍₊₎ and R_{max(+).} The concave shape defines the structure of the self-organized tornado-like jet whose twisting concentrates inside this vortex sucked in small-scale vortexes, swirling and Görtler type vortexes (FIG. 11) forming a fairing in the form of a body of revolution. The concave portion of the dimple surface can be provided with a fairing 5 having a form of a body of revolution whose projections onto the plane containing the normal line towards the concave surfaces and its central meridian are defined by the following relationship: ri2hi=const, where ri is the fairing radius, hi is the fairing height, assuming the values within the range: 10⁻⁵≦rᵢ/R₍₋₎≦1 and 10⁻⁵≦hᵢ/R₍₋₎≦1, or on the concave portion of the relief a dimple is made (FIG. 2 and 3) in which a tertiary tornado-like jet is formed embedded into the secondary tornado-like jet generated by the flow past the relief, the tertiary tornado-like jet acting as a fairing.

The dimple radius rsp of the concave spherical portion of the curvilinear surface having the curvature radius R(−) is defined by the following relationship:

$${r}_{sp} = \sqrt{2 {h}_{sp} {R}_{( - )} - {h}_{sp}^{2}}$$

The suggested method of controlling boundary layers of the flows of gases, liquids and two-phase mixtures thereof is realized by influencing the flow by the boundary surface relief forms designed as a set of alternating and interfaced portions of originally smooth and specially designed curvilinear surface. The flow past such portions generates additional forces, which are absent in the flow past originally smooth surface, resulting in generation at the curvilinear portions having the form shown in FIG. 1 of the secondary tornado-like structures, or jets, localized in the dimples.

We call the suggested form of the boundary surface relief (FIG. 1) the double-curvature relief. This term implies creation on the streamlines surfaces of the curvilinear portions generally characterized by the two dimensions rc and hc, having either a central axial symmetry or an ellipticity along or across the stream. In the case of ellipticity, the characteristics are added with the third dimension. Accordingly, each dimple represents a three-dimensional section of the boundary surface, and its central concave portion 2 is joined to the portions of the originally smooth boundary surface 3 adjacent to the dimple by the convex curvilinear slopes 4.

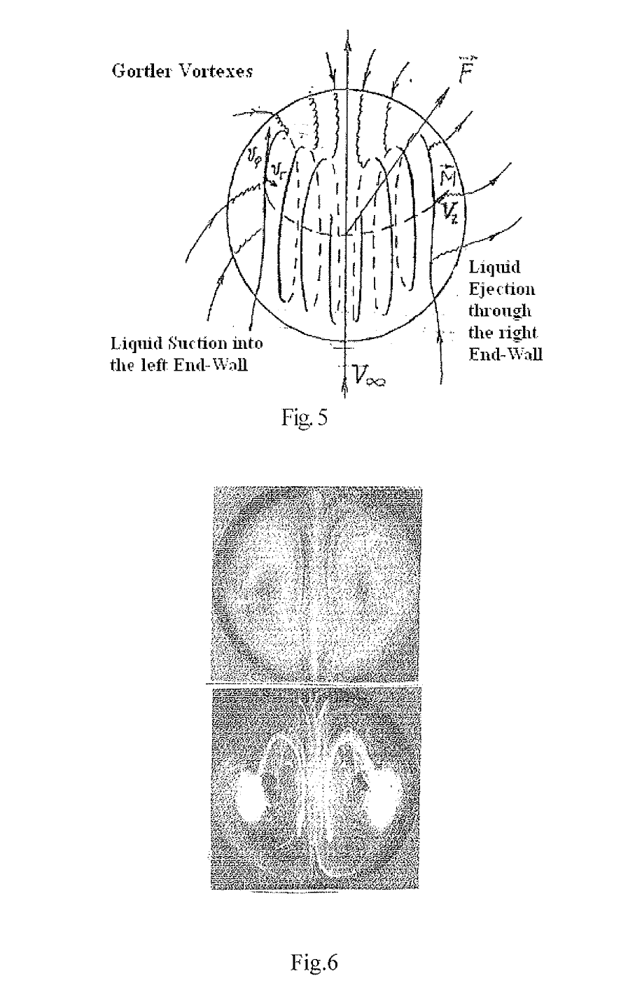

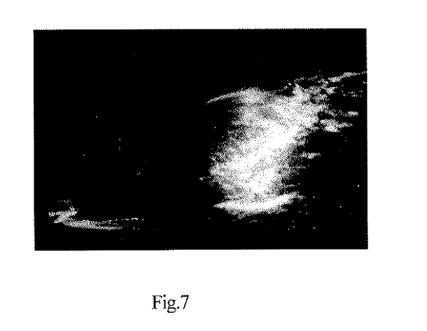

In the course of flowing past such relief, the near wall zones of the flow and its boundary layer are elastically decelerated on the front upstream slopes 4 of the dimple and in its concave portion, which results in that inside the dimple a secondary converging flow is generated a part of which moves along its bottom against the main stream. On the downstream slopes this reversed flow joins the flow moving in the main direction and generating the flow deceleration process in the dimple. As a result of such joining, a secondary twisted structure is formed localized in the dimple, and at low flow velocities corresponding to the flow regimes characterized by Reynolds numbers:

$$Re = \frac{{Ud}_{c}}{v} \leq {10}^{3} ,$$

where dc is the cross dimension, in case of symmetric form—the dimple diameter; the secondary flow in the dimple represents a virtually symmetrical structure visualized in FIG. 6. As the main flow velocity increases, the structure in the dimple loses its symmetry and transforms into a vortex shaft resting with its ends on the streamwise left and right slopes of the dimple (FIG. 7). Inside this secondary structure, due to circulation of the medium, the pressure is lower than in the ambient flow; this causes compression of the vortex structure inside the dimple and generation of a lifting force of the Magnus force type, tearing off the vortex from the dimple surface and pulling one of the vortex ends that is less linked with the curvilinear surface than the other into the main stream. The form of the suggested relieves defined the modification of the boundary layer structure on the boundary surface forming on the curvilinear slopes of the dimples under the ends the near-surface vortexes of the Görtler type or ensembles thereof under the inertial forces; these forces are directed, as is known, along the curvature radii towards its center and influence the flow so that on the convex slopes with the curvature radius R₍₊₎ these forces press the flow to the streamlined convex surface, while on the concave portion of the relief they contribute to removal of the secondary flow from the dimple. Taking into account that these forces are proportional to acceleration on the surface having the curvature of R₍₊₎ or R₍₋₎ (FIG. 5): a≈U²/R, they have a significant effect on generation of the secondary twisted structure in the dimple at relatively high flow velocities and fixed curvature radius R₍₊₎ or R₍₋₎. Taking into account instability of the flow generating the vortex structure and the flow inside the vortex structure itself, the Magnus type lifting force, as described above, tears off one of the vortex ends that is less linked with the surface and pulls it into the main stream transforming the current into the flow with embedded tornado-like jets.

The secondary flow in the dimple, as described above, and indirectly through it the vortex structure in the dimple, is exposed to the Magnus type forces generated due to the medium circulation in the secondary vortex structure; the twisted current sucks in the medium from the dimple surface and adjacent areas of originally smooth surface and transfers this sucked in mass from one of the side slopes of the dimple to the other across the main stream. The sharp border of the vortex structure observed in FIG. 7 and the vortex structure visualized in the dimple (see FIG. 7 and FIG. 11) indicates the centripetal (radially converging) structure of the twisted flow. Circulation in such flow has an axis located either across or under a slight angle to the main stream, which results, as described above, in generation of the Magnus type force directed from the streamlined surface towards the flow and causing lifting of the twisted jet from the dimple and rotation of its axis inside the dimple by ˜45° in relation to the main stream. Increasing the main stream velocity will intensify circulation in the secondary vortex as in the secondary vortex current and main stream joining zone the azimuthal velocity U_{φ}of the secondary vortex in the dimple by its direction and magnitude coincides with the velocity U_{∞} of the main stream which in this zone is equal to (0.3-0.4) U_{∞}. (FIG. 5).

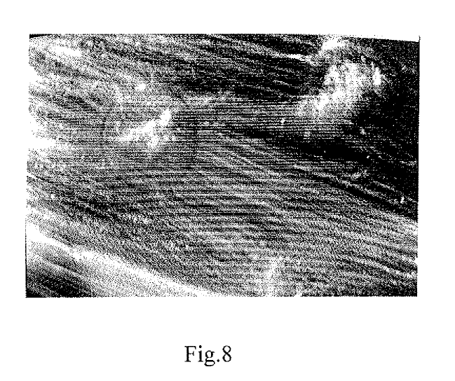

The described mechanism is supported by the diagram and the photographs of the secondary vortex evolution process visualization shown in FIGS. 5, 6, 7 and 8. These diagrams and photographs prove the fact of intensification of the interaction between the vortex and the oncoming main stream with the increase of U_{∞}, lifting and pulling the vortex from the dimple. The effect of suction of the medium from the boundary layer in and around the dimple has been also proved by the measurements of the pressure distribution on the dimple surface in the flow of the medium, which are shown in FIG. 10. The experiment was carried out in a circulation loop filled with distilled water as a working fluid. It follows from FIG. 10 depicting the pressure field in the dimple in the flow that around the dimple there is a zone of reduced pressure as compared with the pressure in the main stream. The reduced pressure zone around the dimple occurs in that portion of the dimple where the convex curvilinear portions are located, and the increased pressure occurs in the central portion of the dimple where the curvilinear surface has a concave form, while the drag forces are directed from the dimple to the main stream, forming a converging twisted centripetal jet. The same effect is illustrated by the photograph in FIG. 8 depicting the process of water flowing past the boundary surface with a double curvature relief. The effect of the reduced pressure on the dimple periphery and generation of the boundary layer from the tree-dimensional near-surface Görtler type vortexes are depicted in the photograph in FIG. 11 where one can see the conical fairing built by the secondary current from the near-surface vortexes sucked into the dimple and stabilizing the process of tornado-like jet flowing out or the dimple.

Accordingly, the described properties and characteristics of the self-organized tornado-like jet result from that the flow past the double-curvature dimples is influenced by the preset forms of these dimples and by the fairing on the concave surface of the dimple (FIG. 11).

The technical result also depends on the degree of curvature and the length of the curvilinear slopes of the dimples, whose ratio of curvatures R₍₊₎ and R₍₋₎ is within the range of 10⁻⁶≦R₍₊₎/R₍₋₎≦1, and the length of the curvilinear portion is defined by the distance between the point of conjunction of the convex portion of the curvilinear surface of the dimple and the point of conjunction of the same convex portion with the concave portion of the dimple surface lying on the common tangent to these curvilinear surfaces (FIG. 1).

Fairness of the streamlined three-dimensional elements of the relief in accordance with the suggested invention also defines enhanced corrosion resistance of the streamlined surface when a continuous medium is used usually causing the corrosion processes. The specific nature of mass transfer by originating large-scale vortex structures, in accordance with the results of the experiments, reduces the aerohydrodynamic drag, acoustic noise, rate of admixture adsorption from the ambient flow to the textured surface, manifesting the above described properties of the new flow, e.g. reducing the probability of electrochemical processes on the textured surface suggested in this invention. The technical result of the invention is achieved within the range of the specified ratios obtained by way of experiments.

### INDUSTRIAL APPLICABILITY

The invention can be applied in various energy exchange systems, including heat and mass exchange systems, and in all other cases where it is required to intensify as compared with the smooth surface the heat and mass exchange with the limited not outpacing the degree of intensification increase of hydraulic resistance, reduce cavitational wear of the surfaces of hydraulic turbines, hydraulic pumps, marine propeller screws and other mechanism, or to reduce as compared with similar smooth surfaces the aerohydraulic drag of streamlined channels or bodies moving in a continuous medium. In particular, the invention can be used in various types of transportation vehicles including aircraft, motor vehicles, high-speed trains, ocean and river vessels, in gas turbine plants with cooled blades in power industry and aviation, in nuclear power assemblies, steam generators, heat-exchanger of various applications, recuperative heat exchangers and other energy exchange apparatuses and devices, in household appliances including air conditioners, fans, heating devices, in kitchen utensils such as teapots, saucepans, frying pans and so on, in various types of sports equipment including sports cars, motorbikes, bicycles, track suits, suits for motor sport, cycling, swimming, running, etc., in medical devices for artificial blood supply, blood purification from harmful admixtures, in artificial respiration units, etc., in other words in all types of flow technologies where the process efficiency depends on the use of moving gases, liquids or two-phase mixtures thereof.

The use of the suggested method and forms of the streamlined surface results in significant increase of the critical heat fluxes within the wide ranges of pressure, mass velocity of the heat carrying medium and relative steam content in it, reduction of aerohydraulic drag, increase of heat-exchange and heat-transfer coefficients, intensification of mass transfer and reduction of cavitational destruction of the surfaces of marine propeller screws, hydraulic turbines, pumps and other hydraulic machines, reduction of harmful substance deposition on a surface including when implementing chemical processes, transporting waste water black water, various biochemical processes involving the motion of gaseous and liquid chemicals, and when developing devices and prostheses for blood circulatory systems.

For example, the shift of the heat exchange crisis towards higher thermal loads is determined by origination in the course of flowing past the textured heated surface of the large-scale self-organized tornado-like structures by means of which a portion of near-surface steam bubbles are evacuated from the surface surrounding the concavity or convex and carried out from the near wall layer to the flow core. This is also facilitated by the three-dimensionality and fairness of the relief elements contributing to the change of orientation and twisting of the vortex structures.

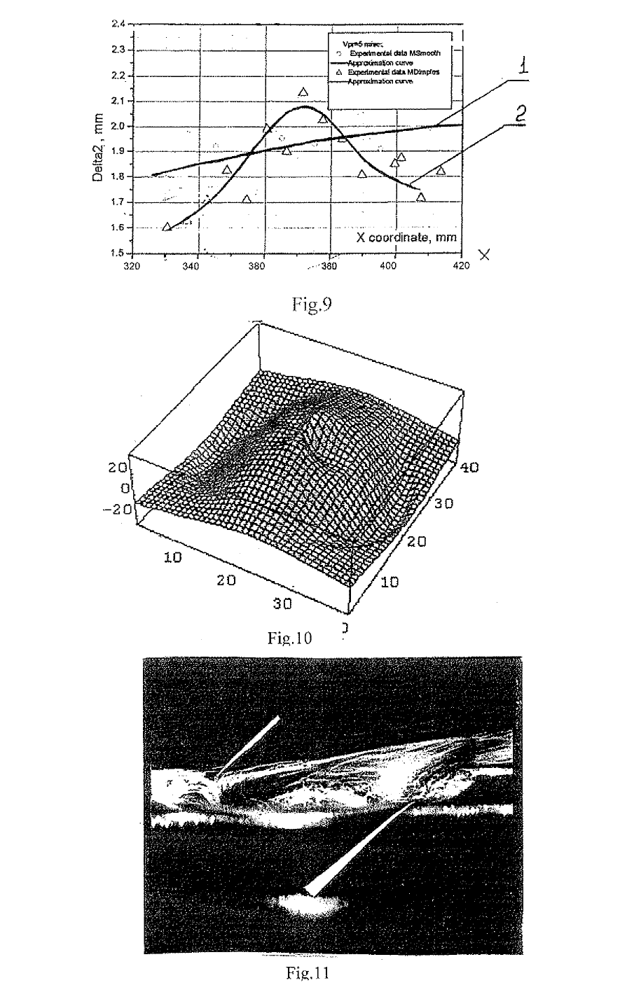

As another example, it can be noted that the forms of relieves suggested in FIG. 1-FIG. 4 make it possible to reduce the frictional drag on such textured surfaces due to origination of the above described forces directed from the surface and reducing the degree of the flow friction against the surface. This is evidenced by the boundary layer thickness measurement results shown in FIG. 9, indicating the reduced thickness of this layer at the surface around the dimple and its suction into the tornado-like jet generated in the dimple (the curve maximum), as it is known that at a fixed oncoming flow velocity the friction drag increase rate reduces.

1. A method of forming a flow with embedded tornado-like jets connecting the flow boundary layer with its core and providing suction of the flow boundary layer from the boundary surface into the main stream, the method comprising:
providing an originally smooth surface;
forming a relief on the originally smooth surface, in which areas of the originally smooth surface alternate with curvilinear areas in the form of dimples, wherein the portion of the dimple surface that adjoins the originally smooth surface has a convex form with the curvature radius R(+), and the other portion of the dimple surface has a concave form with the curvature radius R(−), while the convex and concave portions are joined in the point having a common tangent, and the ratio of their curvature radii is within the range of 10⁻⁶≦(R₍₊₎/R₍₋₎)≦1; and
directing a continuous medium Past the relief-formed surface.

2. An article comprising a surface streamlined by a continuous medium, characterized in that the surface is provided with a curvilinear relief in the form of individual double-curvature dimples each comprising a concave portion of the dimple surface including a spherical surface with the curvature radius R₍₋₎ or an elliptical surface with the curvature radii Rₘᵢₙ₍₋₎ and Rₘₐₓ₍₋₎ joined with the originally smooth surface by means of convex curvilinear toroidal-shaped slopes with the curvature radius R₍₊₎ and/or a hyperbolic or elliptical surface having at the points of conjunction with the originally smooth surface and the surface of the concave form of the relief the curvature radii Rₘᵢₙ₍₊₎ and Rₘₐₓ₍₊₎, their ratio to the curvature radii of the concave portion of the dimple being within the range of 10⁻⁶≦R₍₊₎/R₍₋₎≦1, while the concave portion is made smooth or with a fairing, and the ratio of the depth H of each dimple to the dimple diameter D is within the range of 0.02≦H/D≦0.5, and their location density f on the streamlined surface is within the range of 0.1≦f≦0.8.

3. The article according to claim 2, wherein the fairing has the form of a body of revolution whose projections on the plane containing the normal line towards the center of the concave surface and the central meridian are defined by the relationship rᵢ²hᵢ=const, where rᵢ is the fairing radius, hᵢ is the fairing height assuming the values within the following ranges:
10⁻⁵≦rᵢ/R₍₋₎≦1 and 10⁻⁵≦hᵢ/R₍₋₎≦1,
while the dimple radius rₛₚ of the concave spherical portion of the curvilinear surface with the curvature radius R₍₋₎ is defined from the following relationship:
$${r}_{sp} = \sqrt{2 {h}_{sp} {R}_{( - )} - {h}_{sp}^{2}} ,$$
where hₛₚ is the height of the concave spherical portion of the dimple,
and the curvature radius of the convex portion of the dimple is linked with its dimensions by the following relationship:
$${R}_{( + )} = \frac{{( {r}_{c} - {r}_{sp} )}^{2} + {( {h}_{c} - {h}_{sp} )}^{2}}{2 ( {h}_{c} - {h}_{sp} )}$$
where r_{c} is the dimple radius,
h_{c} is the dimple height.

4. The article according to claim 2, wherein the dimples are provided with a fairing made in the form of at least one secondary dimple located on the concave portions of the relief, generating inside the primary dimples the tertiary tornado-like jet acting as a fairing.

5. The article according to claim 2, wherein the fairing is made in the form of at least one set of dimples of various diameters, located on the concave portion of the primary dimple of the relief.
